(19) United States
(12) Patent Application Publication
(10) Pub. No.: US 2007/0235257 A1
(43) Pub. Date: Oct. 11, 2007

(54) Ladder support and lift system

(76) Inventor: Larry Alexander, Indianapolis, IN (US)

Correspondence Address: DANIEL J. O'CONNOR, 6720 BUCKHORN DRIVE #821, INDIANAPOLIS, IN, 46254, US

(21) Appl. No.: 11/398,932

(22) Filed: Apr. 7, 2006

(51) Int. Cl. E06C 5/00

(52) U.S. Cl. 182/127

(57) ABSTRACT

A ladder lift system and method of use includes a specially designed clamp element which is connected between an extension ladder and a pivotable lift rail. The system includes a lower ladder support. The system is especially adapted for use in combination with the bed of a transport or pick-up truck. The system and method of use allows a single workman to safely and easily utilize an extension ladder for a wide variety of work and service tasks. The invention kit may include a pair of clamp elements with a lower ladder support.

### BACKGROUND AND OBJECTS OF THE INVENTION

The present invention is generally related to the support and lift arts of Class 248 and, in particular, to a ladder lift system and method of use.

For many service and repair usages, an extension ladder is transported on a truck to the work site. Longer extension ladders often require more than one workman for unloading and safe utilization of the extension ladder. The manner of attachment of an extension ladder to a truck also becomes a safety issue, i.e. one must ensure that an extension ladder does not fall off the truck during transport to the work site.

Accordingly, it is an object of the present invention to set forth a novel ladder lift and support system which enables ease of set-up and use by a single workman.

It is a further object to demonstrate a ladder lift system which is mounted on a truck bed and which is utilized from the truck bed position so that no ladder unloading is required.

It is also an object to show a system and method of ladder usage which enhances safety for a workman without costly manufacturing processes and expenses.

It is a still further object of the present invention to demonstrate a novel clamping system which may be economically produced and which results in a ladder lift which is solidly supported and which may be easily moved to various positions at a particular work site.

These and other objects and advantages of the present invention will be apparent to those of skill in the support and ladder lift arts from the description which follows.

### PRIOR ART PATENTS AND DESIGNS

During the course of preparing this specification for submission to the U.S. Patent Office, a full search of the prior art was conducted.

U.S. Pat. Nos. 6,971,563 and 4,990,049 are at least broadly related to the present invention since they teach a combined ladder and pickup truck usage.

Pat. No. 6,971,563 issued to Levi in 2005 claim recites a clamping means adapted to cooperate with two elements to act as a coupling fastener.

The Levi Patent is classified in U.S. Patent Office Classes 224 and 296.

The present invention is submitted to clearly define over the prior art systems and methods of use as they relate to ladders and truck mounted lift designs.

### SUMMARY OF THE INVENTION

A pair of specially designed clamp structures are utilized and positioned between a lift rail and the side rails of an extension ladder.

A lower support and retention element for the ladder is also provided.

Each of the clamp structures has a lower design comprising shoulders which permit mounting to a lift rail. The clamp structures also include an upper section which includes a generally C-shaped device which contacts a side rail of an extension ladder.

The overall system provides for maximum flexibility in use of a ladder at a work site, increased convenience since the ladder need not be removed from a truck, and enhanced safety for a workman since the design provides for a more solid securing of an extension or other type of ladder.

### BRIEF DESCRIPTION OF THE DRAWING FIGURES

FIG. 1 is a schematic side view of the major components used in the claimed combination.

FIG. 2 is a partial view of a ladder to show components, such as side rails, which are recited in the combination.

FIG. 3 is a perspective view of the clamp elements used in the invention.

FIG. 4 is a view of the lower and middle sections of the clamp structure.

FIGS. 5 and 6 are end and side views, respectively, of the top and middle portions of the clamp structure.

FIG. 7 is a perspective view of the lower ladder support utilized in the invention.

FIG. 8 is an overall view of the system components including the two clamp elements and the lower ladder support and retainer device. These three components may be marketed, for example, in a kit form for widespread distribution in the repair and construction arts.

### FULL DESCRIPTION OF THE PREFERRED EMBODIMENTS

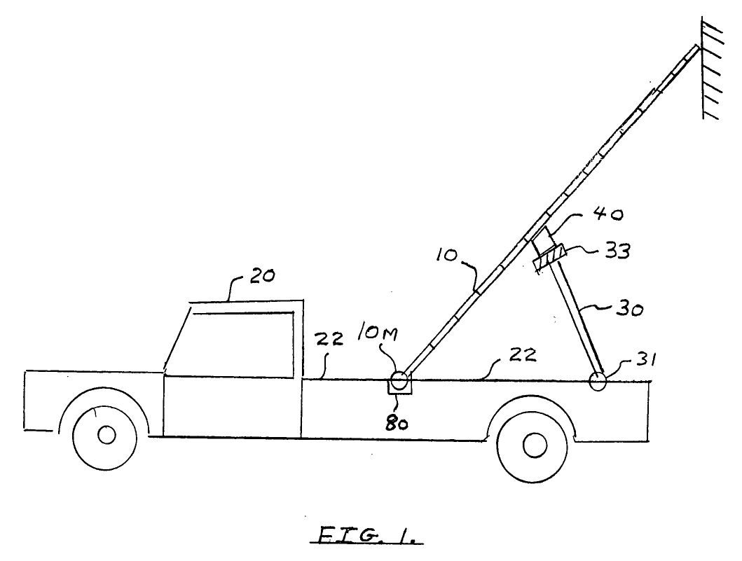

Referring to the drawing FIG. 1, the overall system is shown as being used in combination with the bed 22 of a truck 20.

A lift structure 30 is shown as being pivotable about point 31 which is mounted to the truck bed 22.

The lift 30 has an upper or top rail 33 which is very sturdy and is of a generally square or rectangular cross section.

An extension ladder is indicated at numeral 10 and as having a lower mounting point or area at numeral 10M.

As further indicated schematically in FIG. 1, clamp elements 40 are positioned to join the top rail 33 to side rails of the ladder 10.

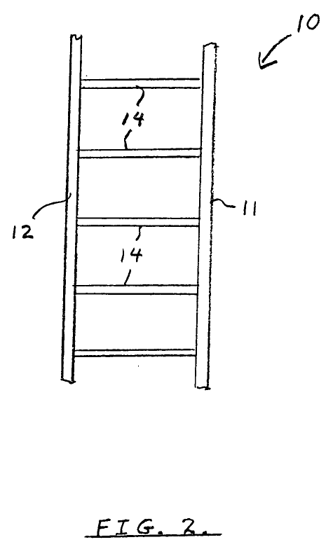

FIG. 2 shows a portion of a conventional extension ladder 10 which has side rails indicated at 11 and 12 and rungs as shown at 14.

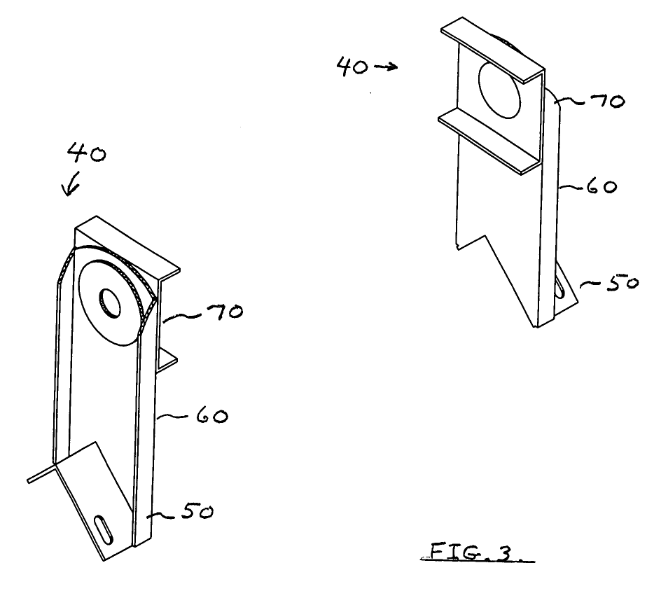

FIG. 3 shows a perspective view of the pair of clamps 40 which have been specially designed for use in the overall ladder lift and support system.

For the purposes of illustration and clear description, the clamps 40 are divided into lower section 50, middle section 60 and upper section 70.

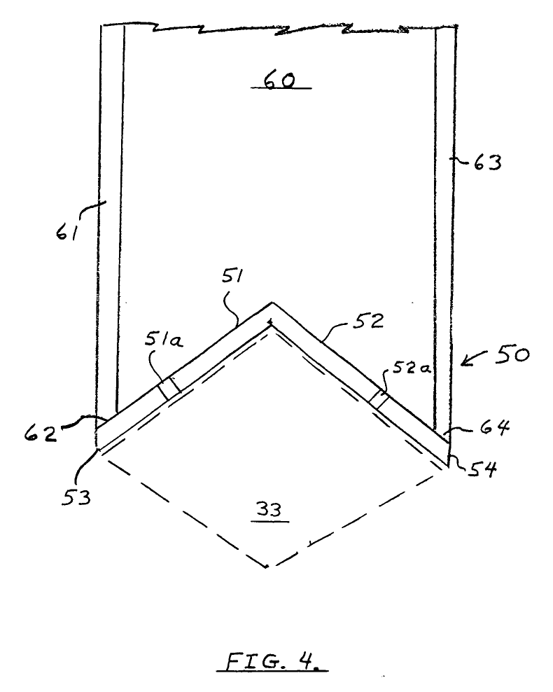

Referring to FIG. 4, which shows the lower section 50 and the middle section 60, there is shown a first shoulder section 51 and a second shoulder section 52. The shoulders 51 and 52 are mounted to the top rail element 33 by means of bolt apertures 51a and 52a.

As further shown, the shoulders are at about ninety degrees to each other and have lower edges 53 and 54 respectively.

The middle section 60 has upwardly extending side rails 61 and 63, left and right, which have respective lower portions 62 and 64.

As indicated, the lower edges of the shoulder sections are affixed to the lower rail portions.

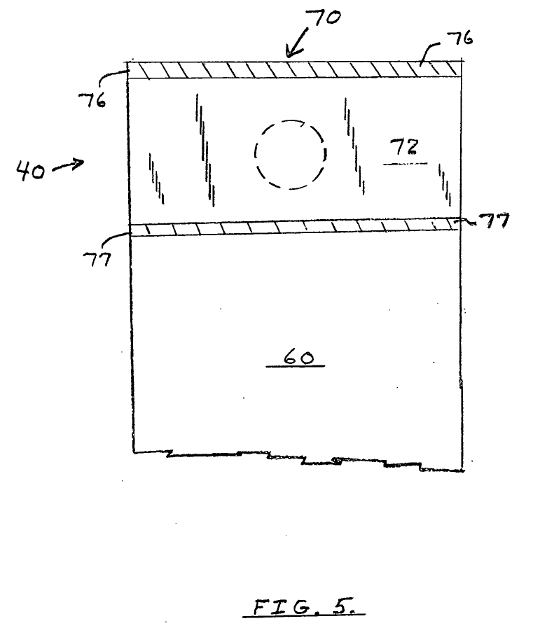

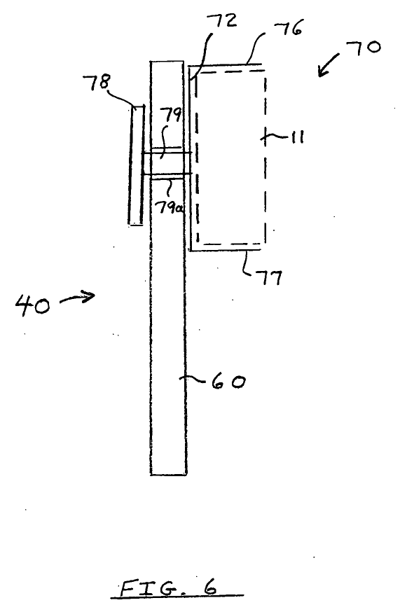

Referring to FIGS. 5 and 6, showing the upper portion 70 of clamp 40, elements 72, 76 and 77 comprise a grasping element for contacting a ladder side rail shown schematically at numeral 11 of FIG. 6.

The grasping element is generally C-shaped and is retained to the upper section 70 by means of a disc-shaped backing plate 78 and a connector element 79 which extends through aperture 79a in the upper section 70.

As shown in FIG. 3, the C-shaped element is on the opposite side of the overall clamp 40 from the angled shoulder portions.

The arrangement shown enables a swivel motion of the C-shaped grasping element.

Thus, convenient positioning of an extension ladder is achieved.

It is contemplated that the materials utilized for the fabrication of clamp elements 40 would comprise high-strength metals or hybrid compounds of a type known in the manufacturing arts.

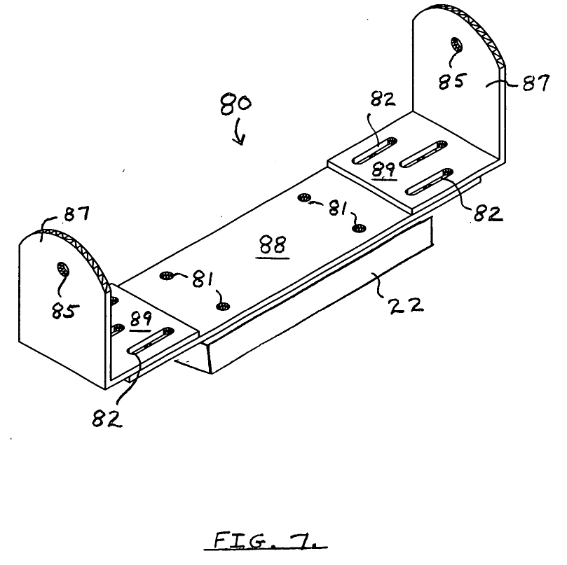

FIG. 7 shows a lower retainer and support structure 80 which retains a lower end of an extension ladder to a truck bed 22.

Retainer structure 80 includes bolt apertures 81 which cooperate with suitable fasteners to affix the retainer 80 to bed 22.

Lower retainer 80 has side wings 87, a lower plate 88 and slide plates 89.

Slotted apertures 82 provide for an adjustment of the retaining member 80 to accomodate extension ladders of various sizes.

Bolt apertures 85 are utilized to affix the lower end of an extension ladder to the lower retainer structure 80.

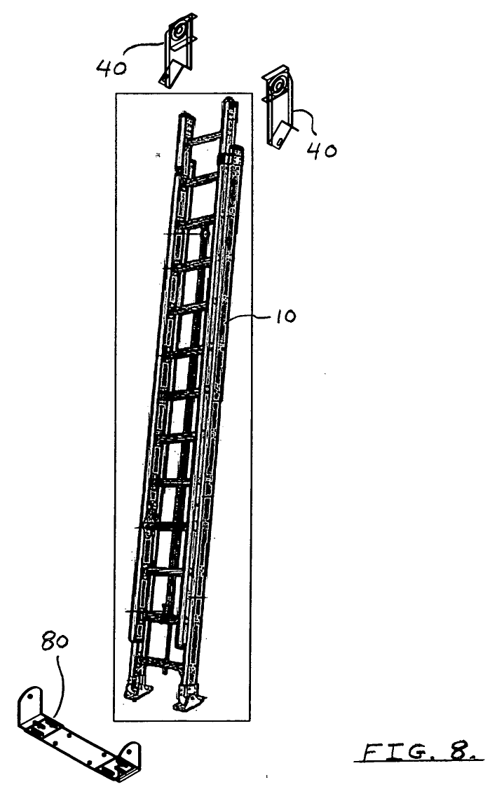

The lower retainer and support structure 80 is shown in FIG. 8 with the combined extension ladder and the two clamp units 40 which would be used in practice of the invention.

As indicated generally in FIG. 8, the system components comprising two clamp units 40 and the lower retainer structure 80 may be marketed in the form of a three-piece kit for widespread distribution of the system and method of use.

The method steps utilized in practice of the invention are as follows:
A) attaching a pivotable lift 30 having an upper lift rail 33 to a truck bed 22,
B) attaching a lower ladder support 80 to a truck bed 22,
C) attaching an extension ladder to the lower ladder support in a pivotable fashion,
D) pivoting the ladder lift to a desired position,
E) attaching the extension ladder to a top rail of the ladder lift using the overall clamp and attaching structure 40.

The method steps utilize the structures which have been previously illustrated including the clamp units 40 and the lower ladder support 80.

While a particular system and method of use have been described and illustrated, it is intended in this specification to cover all equivalent systems and methods which would reasonably occur to those of skill in the art. For example only, the system may be arranged so that the ladder extends to lateral or front locations.

The invention is further defined by the claims appended hereto.

I claim:

1. A ladder lift and support clamp device including:
a lower section which contacts a lift rail, said lower section having a first shoulder section and a second shoulder section which is at an angle of ninety degrees to said first shoulder section, said first shoulder section having a lower edge and said second shoulder section having a lower edge, said support clamp structure including a middle section which comprises a flat plate with a left rail having a lower portion and a right rail having a lower portion,
wherein the lower edge of said first shoulder section is affixed to the lower portion of the left rail, wherein the lower edge of said second shoulder section is affixed to the lower portion of the right rail, said ladder support clamp further including an upper section which contacts part of an extension ladder, said upper section including a generally C-shaped element which is mounted via a backing disc to the upper section.

2. The ladder lift and support clamp device of claim 1 wherein said clamp device is utilized, in combination, in a system including a lower ladder support and retainer, an extension ladder and a lift structure having a sturdy top rail element, said system further including a truck and a truck bed.

3. The combined system of claim 2 wherein said lower ladder support and retainer includes side wings, a lower plate and slide plates, bolt apertures being provided to attach the lower end of an extension ladder to the lower ladder support and retainer, bolt apertures being provided in the lower plate to affix the device to a truck bed.

4. The combined system of claim 3 further including a second clamp device which forms attaching means between a top rail of a lift and a side rail of an extension ladder, wherein said C-shaped element is on an opposite side of said clamp device from said shoulder sections.

5. A method of using an extension ladder in combination with the bed of a truck comprising the following steps:
A) attaching a pivotable lift having an upper lift rail to a truck bed,
B) attaching a lower ladder support to a truck bed,
C) attaching an extension ladder to the lower ladder support in a pivotable fashion,
D) pivoting the ladder lift to a desired position,
E) attaching the extension ladder to a top rail of the ladder lift using clamping means for connecting a ladder side rail to said top rail.

6. A three-piece kit for mounting an extension ladder to a bed of a pickup truck, said kit including a ladder retainer and support structure and a pair of clamping means for connecting a top rail of a lift to side rails of a ladder.
